(19) United States
(12) Patent Application Publication
(10) Pub. No.: US 2011/0189624 A1
(43) Pub. Date: Aug. 4, 2011

(54) LAYERED ORTHODONTIC BRACKET AND METHOD OF MAKING SAME

(75) Inventor: Raymond F. Wong, Chino Hills, CA (US)

(73) Assignee: ORMCO CORPORATION, Orange, CA (US)

(21) Appl. No.: 13/018,864

(22) Filed: Feb. 1, 2011

Related U.S. Application Data
(60) Provisional application No. 61/300,693, filed on Feb. 2, 2010.

(51) Int. Cl. A61C 7/28

(52) U.S. Cl. 433/10

(57) ABSTRACT

An orthodontic bracket has an archwire slot adapted to receive an archwire therein and comprises a core and an overmolded polymeric cover that covers the core. The polymer of the overmolded polymeric cover is cross-linked. The thickness and the cross-linked density of the cover are sufficient to limit chemicals found in an oral environment from passing through the cover during treatment. In an embodiment, the core comprises a polycarbonate and the cover comprises a polyurethane. A method of making an orthodontic bracket comprises providing a core and overmolding a polymeric cover over at least a portion of the core and cross-linking the polymer of the polymeric cover. In another embodiment, a method of molding an orthodontic bracket comprises injecting a first polymer into a mold cavity to form a polymeric core and injecting a second polymer into the mold cavity to form an overmolded polymeric cover over the core.

This application claims the benefit of U.S. Provisional Application Ser. No. 61/300,693, filed on Feb. 2, 2010, the disclosure of which is expressly incorporated by reference herein in its entirety.

### TECHNICAL FIELD

The present invention is directed to orthodontic brackets and, more particularly, to aesthetically pleasing orthodontic brackets containing a polymer.

### BACKGROUND

Orthodontic brackets represent a principal component of corrective orthodontic treatment devoted to improving a patient's occlusion. In conventional orthodontic treatment, an orthodontist or an assistant affixes orthodontic brackets to the patient's teeth and engages an archwire into a slot of each bracket. The archwire applies corrective forces that coerce the teeth to move into orthodontically correct positions. Traditional ligatures, such as small elastomeric O-rings or fine metal wires, are employed to retain the archwire within each bracket slot. Due to difficulties encountered in applying an individual ligature to each bracket, self-ligating orthodontic brackets have been developed that eliminate the need for ligatures by relying on a movable latch or slide for captivating the archwire within the bracket slot.

Conventional orthodontic brackets are ordinarily formed from stainless steel, which is strong, nonabsorbent, weldable, and relatively easy to form and machine. Patients undergoing orthodontic treatment using metal orthodontic brackets, however, may be embarrassed by the visibility of metal, which is not cosmetically pleasing. To address the unsightliness of metal brackets, certain conventional orthodontic brackets incorporate a bracket body of a transparent or translucent non-metallic material, such as a clear or translucent polymer or a clear or translucent ceramic, that assumes the color or shade of the underlying tooth. Thus, forming bracket bodies from transparent/translucent material, for example ceramic materials, has become desirable. However, ceramic materials in particular are brittle and are subject to a greater likelihood of fracture during use. In addition, ceramic materials tend to be harder than tooth enamel. This may create concerns in cases where a clinician has to treat a patient exhibiting a type of malocclusion in which one or more teeth on the opposing arch contacts the ceramic bracket when the patient's jaws close. In this situation, the ceramic brackets may wear away the tooth enamel at the area of contact. To avoid such an outcome, the clinician may revert back to the non-aesthetically pleasing metal brackets, thus limiting the full implementation of aesthetic brackets.

While translucent polymer brackets are an alternative to transparent or translucent ceramic brackets, they often are not durable enough. In particular, the mechanical properties of polymeric brackets often deteriorate to unacceptable levels over the course of treatment. As a consequence, the clinician may have to extend the patient's treatment, or the clinician may have to replace the brackets one or more times at some point prior to the conclusion of treatment, which is costly and inconvenient. Furthermore, unlike translucent ceramics, polymeric orthodontic brackets may rely on metallic inserts to provide mechanical endurance. The metallic inserts are typically used to line the archwire slot for strengthening and reinforcing the bracket body in the vicinity thereof. Using a metallic insert, without more, to provide increased strength essentially amounts to a compromise between strength and aesthetics, since the metallic insert is typically readily visible in the patient's mouth.

Polymeric orthodontic brackets may alternatively contain reinforcing agents to enhance the durability of the brackets. However, there has been little success in using reinforcing agents to improve the durability of the polymeric bracket. In order to address durability, specifically abrasion resistance, the polymer may be coated. For example, coatings of a hard abrasion resistant material may be deposited, sprayed, dipped on, or even painted on the polymeric bracket in order to enhance the wear resistance of the polymer. These processes may provide a relatively thin coating of, at most, a few microns. However, hard coatings often fail due to the dissimilarity of the coating compared to the underlying bracket material such that slight deformation of the bracket often causes the coating to spall or flake off during use. Consequently, polymeric brackets with hard coatings often fail during use. Other coatings, such as polymeric coatings, may also find use on polymeric brackets. These coatings may be formed by painting, spraying, or dip coating resulting in a thin coating having substantially uniform thickness over the surfaces of the bracket. However, the coated bracket often degrades in the biochemical environment found in the human mouth over the course of orthodontic treatment in spite of the coating.

Consequently, there is a need for an orthodontic bracket that can withstand the loads needed to move teeth to their orthodontically correct positions, that can endure the biochemical environment found in the oral environment without substantial degradation in mechanical properties or aesthetics, and that does not otherwise negatively impact the patient's teeth during treatment.

### SUMMARY

To these ends, in one embodiment of the invention, an orthodontic bracket having an archwire slot that is adapted to receive an archwire therein comprises a core and an overmolded polymeric cover that covers the core. The polymer of the overmolded polymeric cover is cross-linked, whereby the thickness and the cross-linked density of the overmolded polymeric cover are sufficient to limit chemicals found in an oral environment from passing through the overmolded polymeric cover during orthodontic treatment.

In another embodiment, an orthodontic bracket having an archwire slot that is adapted to receive an archwire therein comprises a polymeric core comprising a polycarbonate and an overmolded polyurethane cover that covers at least a portion of the polymeric core. The overmolded polyurethane cover has a thickness that varies across the surface of the polymeric core and is cross-linked such that the thinnest portion of the overmolded polymeric cover substantially prevents water or other chemicals found in an oral environment from passing through the overmolded polyurethane cover during orthodontic treatment.

In another embodiment, a method of making an orthodontic bracket having an archwire slot for receiving an archwire therein comprises providing a core and overmolding a polymeric cover over at least a portion of the core. The method further includes cross-linking the polymer of the polymeric cover. The thickness and the density of cross-links of the overmolded polymeric cover are sufficient to limit water or other chemicals found in an oral environment from passing through the overmolded polymeric cover during orthodontic treatment.

In another embodiment, a method of molding an orthodontic bracket comprises injecting a first polymer into a mold cavity to form a polymeric core and injecting a second polymer into the mold cavity to form an overmolded polymeric cover over at least a portion of the polymeric core. The overmolded polymeric cover has a thickness sufficient to limit water or other chemicals found in an oral environment from passing through the overmolded polymeric cover during orthodontic treatment.

### BRIEF DESCRIPTION OF THE DRAWINGS

The accompanying drawings, which are incorporated in and constitute a part of this specification, illustrate embodiments of the invention and with the general description given above, together with the detailed description given below, serve to explain various aspects of the invention.

FIG. 1A is a perspective view of an orthodontic bracket in accordance with one embodiment of the invention illustrating a polymeric cover drawn in solid line and a core drawn in hidden line;

FIG. 1B is a perspective view of the orthodontic bracket of FIG. 1A with the polymeric cover drawn in phantom and the core drawn in solid line;

FIG. 2 is a cross-sectional view of the orthodontic bracket shown in FIG. 1A taken along section line 2-2;

FIG. 3 is an alternative cross-sectional view of one embodiment of the orthodontic bracket shown in FIG. 1A taken along section line 2-2;

FIG. 4 is a perspective view of an orthodontic bracket in accordance with one embodiment of the invention illustrating an insignia, identifier, or decorative element; and

FIG. 5 is a cross-sectional view of the orthodontic bracket shown in FIG. 4 taken along section line 4-4.

### DETAILED DESCRIPTION

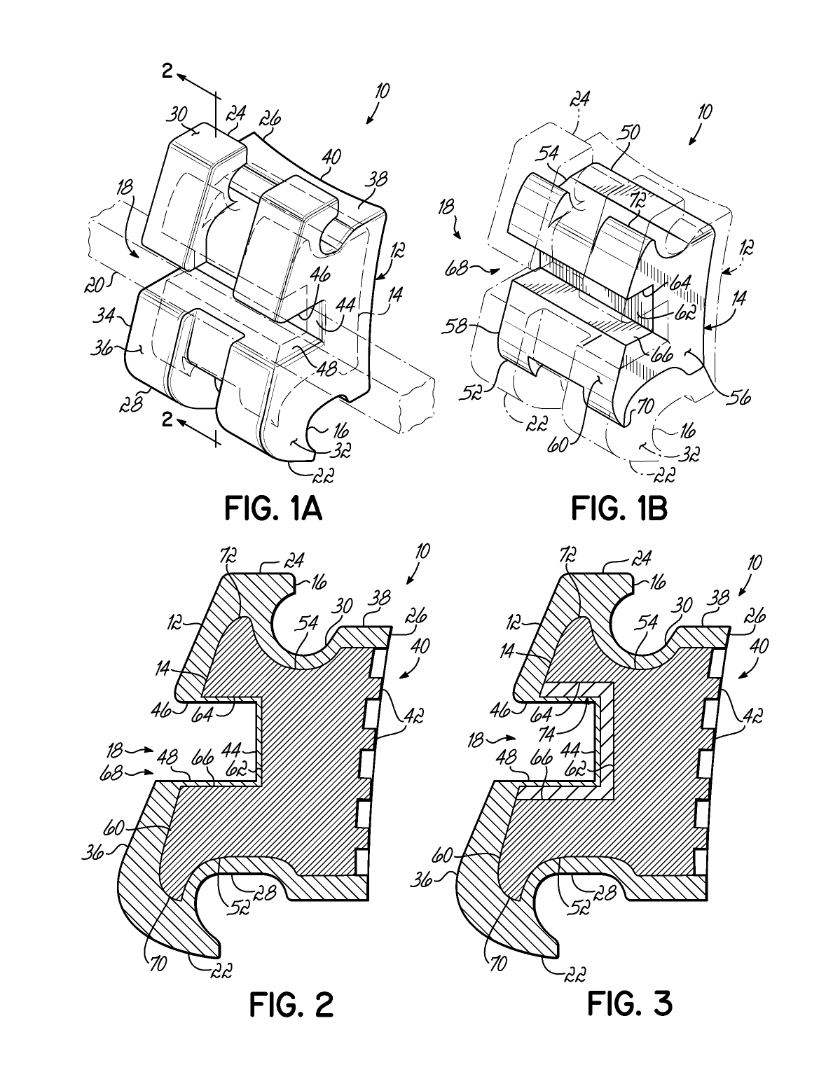

Referring to FIGS. 1A and 1B, there is illustrated an orthodontic bracket 10 comprising a body 12. As shown, the body 12 is not a monolith. Rather, the body 12 includes a core 14 (shown in phantom in FIG. 1A and in solid line in FIG. 1B) and a polymeric cover 16 (shown in solid line in FIG. 1A and in phantom in FIG. 1B). The polymeric cover 16 covers at least a portion of the core 14 such that the body 12 has a layered or laminated structure. In one embodiment, the polymeric cover 16 is in direct and continuous contact with the core 14. As is described in more detail below, the body 12 may be made via an overmolding, stage-molding, co-injection molding, casting, or similar process. Furthermore, while a single core 14 and polymeric cover 16 are shown, it is contemplated that multiple cores and/or multiple covers may be utilized in accordance with the present invention.

As shown in FIG. 1A, the body 12 has an archwire slot 18 which is configured to receive archwire 20 (shown in phantom) for applying corrective forces to the tooth. In addition, the body 12 has opposing occlusal and gingival tie wings 22, 24, respectively, for receiving one or more ligatures (not shown), as is known in the art. However, while tie wings 22, 24 and ligatures are described herein, embodiments of the present invention are not limited only to those brackets having tie wings or that utilize ligatures to secure the archwires thereto. Rather, self-ligating brackets that have a separate slide or closure member (not shown), with or without tie wings, for capturing the archwire within the body are also contemplated as being within the scope of the present invention.

The orthodontic bracket 10, unless otherwise indicated, is described herein using a reference frame with the bracket 10 attached to a labial surface of a tooth on the upper jaw. Consequently, as used herein, terms such as labial, lingual, mesial, distal, occlusal, and gingival used to describe bracket 10 are relative to the chosen reference frame. The embodiments of the invention, however, are not limited to the chosen reference frame and descriptive terms, as the orthodontic bracket 10 may be used on other teeth and in other orientations within the oral cavity. For example, the bracket 10 may also be located on the lower jaw or mandible and be within the scope of the invention. Those of ordinary skill in the art will recognize that the descriptive terms used herein may not directly apply when there is a change in reference frame. Nevertheless, the invention is intended to be independent of location and orientation within the oral cavity and the relative terms used to describe embodiments of the orthodontic bracket are to merely provide a clear description of the examples in the drawings. As such, the relative terms labial, lingual, mesial, distal, occlusal, and gingival are in no way limiting the invention to a particular location or orientation.

When the bracket 10 is mounted to the labial surface of a tooth carried on the patient's upper jaw, the body 12 has a lingual side 26, an occlusal side 28, a gingival side 30, a mesial side 32, a distal side 34, and a labial side 36. The lingual side 26 of the body 12 is configured to be secured to the tooth in any conventional manner, for example, by an appropriate orthodontic cement or adhesive or by a band around an adjacent tooth (not shown).

As shown best in FIG. 2, the lingual side 26 may further be provided with a pad 38 that defines a bonding base 40 adapted to be secured to the surface of the tooth. The pad 38 may be integrally formed with the body 12 or be of a separate element coupled to body 12 (not shown). The bonding base 40 may include a plurality of pegs or posts 42 thereon for improving bond strength with an adjacent tooth. The posts 42 increase the contact area between the adhesive and the bracket 10 and thereby increase the bond strength. Additionally, the posts 42 may be further configured to increase the bond strength. For example, the posts 42 may be flattened or deformed at an outer end thereof so as to create undercuts (not shown). Adhesive fills the undercuts to, in essence, create a mechanical lock between the bonding base 40 and the adhesive. In one embodiment, the posts 42 may be integrally formed with the bonding base 40. Other features in addition to, or in lieu of, posts 42 may be included to increase the bond strength between the bracket 10 and tooth via a suitable adhesive. For example, the surface roughness of the bonding base 40 may be increased. In this regard, micro or macro protrusions, recesses, or undercuts or other similar features may be formed thereon using a laser or other suitable technique.

With reference to FIG. 1A, the body 12 includes a base surface 44 and a pair of opposed slot surfaces 46, 48 projecting labially from the base surface 44 that collectively define the archwire slot 18 in the body 12. The archwire slot 18 extends in a mesial-distal direction from mesial side 32 to distal side 34. The archwire slot 18 of the body 12 may be configured to receive the orthodontic archwire 20 in any suitable manner.

As shown in FIG. 1B, the core 14 has a lingual side 50, an occlusal side 52, a gingival side 54, a mesial side 56, a distal side 58, and a labial side 60. These sides generally correspond in orientation to the sides 26, 28, 30, 32, 34, 36, of the body 12, respectively (labeled in FIG. 1A). Similar to the base surface 44 and opposed slot surfaces 46, 48 of the body 12, shown in FIG. 1A, the core 14 has a support surface 62 and opposed slot surfaces 64, 66 projecting labially from the support surface 62 that collectively define a core slot 68. The core slot 68 extends from the mesial side 56 to the distal side 58 of the core 14.

In the exemplary embodiment depicted in FIG. 1B, the core 14 has opposing occlusal and gingival support wings 70, 72. The support wings 70, 72 may generally correspond to tie wings 22, 24 of the body 12, and may be configured to support the respective tie wings 22, 24 to hold ligatures (not shown) for securing the archwire 20 within the archwire slot 18. However, as is described in more detail below, the core 14 need not have either of support wings 70, 72, particularly where the body 12, as set forth above, does not have either of the opposing tie wings 22, 24.

With continued reference to FIG. 1B, the core 14 reinforces the body 12. In this respect, the core slot 68 is shaped and positioned in proximity to the archwire slot 18. The material of the core 14 is characterized as having a strength, fracture toughness, and impact strength sufficient for transmitting forces from the archwire 20 and/or tensioning devices to the tooth, as well as, absorbing occasional impact from normal mastication without failure. In one aspect, the core 14 is designed to be generally rigid or stiff. For example, the material of the core 14 may have a greater modulus of elasticity than the modulus of elasticity of the polymer of the polymeric cover 16. The core 14 thereby substantially resists permanent deformation and allows the body 12 to essentially maintain its designed geometry for transmitting loads from the archwire 20 to the tooth. In addition to rigidity, the core 14 may also be characterized by sufficient toughness and/or fracture toughness such that the body 12 resists failure due to impact during mastication, particularly those generated while chewing hard foods. In one embodiment, the core 14 has a greater fracture toughness than that of the polymeric cover 16.

Furthermore, in order to achieve the desired aesthetic characteristics, the core 14 may be substantially transparent, translucent, or tooth colored. A transparent material transmits light with little or no light absorption or scattering, that is, the transmittance of light through a transparent material may approach 100%. In this regard, the details of an object behind a transparent material may be discerned when the object is viewed through the transparent material. On the other hand, a translucent material allows light to pass through it diffusely. In other words, a translucent material transmits less than 100% of the light that enters it. Typically, a transmittance of less than 100% is the result of absorption and/or scattering of light, which may be the result of microstructural features, such as grain boundaries, porosity, or scattering centers, like pigments, within a ceramic or polymer. Alternatively, the core 14 may be sufficiently thick to absorb and/or scatter any visible light that is not initially reflected at its surface. This results in an opaque, though tooth-colored, bracket 10. In one embodiment, the core 14 may have a luminous transmittance (i.e., the transmittance of light having a wavelength in the visible spectrum) of at least 40% as measured by ASTM D1003.

Taking into account the function of the core 14 as set forth above, the core 14 may be made of one or more ceramics or one or more plastics or a combination thereof. In embodiments where the core 14 is ceramic, it may be made of alumina (Al₂O₃); zirconia (ZrO₂); a multiphase ceramic, such as alumina having a dispersed phase of zirconia or hafnia, or others, as are described in U.S. Pat. No. 4,298,385, which is incorporated by reference herein in its entirety; a glass ceramic, such as that described in U.S. Pat. No. 4,789,649, which is also incorporated by reference herein in its entirety; a high strength glass; or combinations thereof or other suitable ceramic materials. The ceramic may be transparent or translucent. In this embodiment, where the core 14 is transparent or translucent and the polymeric cover 16 is also transparent or translucent, the body 12 may blend into the background of the attached tooth and thus be less noticeable to casual observers. Alternatively, the ceramic may be inherently tooth colored.

In a further embodiment, as set forth above, the core 14 may be made of a plastic, such as a thermoset or thermoplastic polymer. By way of example only, and not limitation, the core 14 may be a polycarbonate or an ionomer, such as Surlyn® supplied by E. I. Du Pont De Nemours and Company Corp. In one embodiment, the polymer of the core 14 has a greater elastic modulus than the elastic modulus of the polymer of the polymeric cover 16. Any translucent or tooth-colored characteristics may be obtained by addition of a tint, a colorant, and/or another additive, which may include a reinforcing agent. The reinforcing agent may enhance the rigidity or other mechanical attributes of the core 14 and may also make the core 14 translucent. The reinforcing agent may be particles or fibers of glass or other similar material that are encased within the core 14.

Referring to FIG. 1A, the polymeric cover 16 may form a majority of the exterior surfaces of the body 12. In particular, the polymeric cover 16 may form the exterior surface of the body 12 along each of the occlusal side 28, gingival side 30, mesial side 32, distal side 34, and labial side 36 thereby covering the corresponding sides 50, 52, 54, 56, and 58 of the core 14 shown in FIG. 1B. In one embodiment, the polymeric cover 16 forms all of the exterior surfaces of the bracket 10 when the bracket 10 is mounted on the labial surface of a tooth. In particular, as is shown best in FIG. 2, the slot surfaces 44, 46, 48 are formed by the polymeric cover 16 and thus the polymeric cover 16 covers each of the surfaces 62, 64, 66 of the core slot 68.

In one embodiment, and with reference to FIG. 2, the polymeric cover 16 may not cover the lingual side 26 of the body 12. Rather, in this embodiment, the core 14 may extend to and form the bonding base 40 and posts 42. It will be appreciated that when the bracket 10 is adhesively bonded to a tooth, the adhesive (not shown) may prevent penetration of fluids from the oral environment such that the polymeric cover 16 along this side of the core 14 is not needed. It will also be appreciated, however, that the polymeric cover 16 may cover the core 14 along the lingual side 26 of the body 12, such that, in one embodiment, the polymeric cover 16 fully encases the core 14.

The thickness of the polymeric cover 16 in combination with the polymer of the polymeric cover 16, as set forth below, is configured to protect the core 14 from degradation. In this regard, the polymeric cover 16 is configured to have sufficient tear strength, abrasion resistance, and chemical resistance to protect the core 14. In other words, the cover 16 has high durability in the oral environment. For example, the thickness of the polymeric cover 16 at locations where the polymeric cover 16 covers the core 14 is sufficient to make a hermetic and/or watertight seal between the core 14 and the environment at the covered location. In particular, the polymeric cover 16 at least protects the core 14 from significant degradation by preventing absorption of water, enzymes, and proteins from biological fluids, gases, and chemicals found in foods and beverages. While the polymeric cover 16 may have a uniform thickness over the sides 50, 52, 54, 56 and 58 of the core 14, the thickness of the polymeric cover 16 may be selectively varied, as shown for example in FIG. 2. The thickness of the polymeric cover 16 may be measured along a line that is perpendicular to the surface of the core 14 and that intersects the surface of cover 16. By way of example, the thickness of the portion of the polymeric cover 16 that lines the core slot 68 may be measured along a line that is perpendicular to one of the support surfaces 62, 64, 66 and that intersects the corresponding surface 44, 46, or 48. The thickness may be the distance measured along the perpendicular line from the support surface 62, 64, 66 to the corresponding surface 44, 46, 48.

With continued reference to FIG. 2, the thickness of the polymeric cover 16 may vary within, or between any of, the sides 26, 28, 30, 32, 34, 36 of the body 12, including the surfaces 44, 46, 48 of the archwire slot 18. By way of example only, the thickness of the polymeric cover 16 in the archwire slot 18 may be at least about 100 μm. By way of further example, the polymeric cover 16 that forms the surfaces of the tie wings 22, 24 may have a thickness that is at least about 100 μm. However, it is preferable that the thickness is at least 125 μm along the tie wings 22, 24 and archwire slot 18. In addition, the thickness of the polymeric cover 16 may be increased at locations subject to normal surface contact or interarch contact to account for the material that may be gradually worn away due to this contact. In this respect, the thickness of the polymeric cover 16 may be selectively varied to account for normal wear, if any, such that the polymeric cover 16 remains of sufficient thickness to protect the core 14 during treatment. Accordingly, increased thickness may improve longevity of the bracket 10 in the oral environment. In one embodiment of the invention, the thickness of the polymeric cover 16 determines the corresponding dimensions of the core 14.

As the thickness of the polymeric cover 16 varies, the shape or dimensions of the core 14 may also vary for a particular bracket design. In the exemplary embodiment depicted in FIGS. 1A and 1B, the core 14 has a similar shape as the body 12, though the core 14 occupies a lesser volume. In one embodiment, the difference between the shape of the core 14 and that of the body 12 is filled by the polymeric cover 16. As shown, even where the shape of the core 14 and body 12 are similar, there may be some variation in the thickness of the polymeric cover 16. It will be appreciated, however, that in alternative embodiments the core 14 may have other shapes unlike that shown in FIGS. 1A and 1B in which the core 14 may mimic the shape of the body 12 or be an entirely different configuration than the body 12. For example, the shape of the core 14 may be configured to optimize the mechanical properties of the bracket 10. In particular, the core 14 may be shaped to carry and transfer more of the mechanical load generated by the archwire 18 during orthodontic treatment than the polymeric cover 16.

As shown in the exemplary embodiments of FIGS. 2 and 3, the core 14 may form a majority of the bonding base 40, except for possibly a portion of the cover 16 that surrounds the core 14. Advantageously, and unlike an orthodontic bracket having an insert that is encapsulated in another material such that the insert does not contact the tooth, the loads imposed on the body 12 by the archwire 20 may be carried by the core 14 and transferred directly to a tooth (not shown). Furthermore, in this regard and with continued reference to FIG. 2, the thickness of the polymeric cover 16 may be reduced in and around the archwire slot 18, thereby positioning the core slot 68 more closely to the archwire slot 18. The core 14, therefore, reinforces the archwire slot 18 and more directly carries loads imposed by the archwire 18. While the polymeric cover 16 may be reduced in the archwire slot 18, it is sufficiently thick to prevent degradation of the core 14 particularly in the core slot 68, as described above. Other properties, like the appearance or transparency/translucency, may also be controlled by the shape of the core 14, the thickness of the polymeric cover 16, and/or the type and amount of any reinforcing agents in the core 14 and/or polymeric cover 16. In one embodiment, the bracket 10 is characterized by no less than 40% luminous transmittance.

The polymeric cover 16 may be made of one or more thermoplastic or thermoset polymers or resins suitable for use in the human mouth. Exemplary polymers include polyurethanes, ionomers, or polycarbonates. Other exemplary polymers include polysulphone, acrylic, polyamide, acrylonitrile-butadiene-styrene terpolymer, or polyethylene terephthalate. In a further example, the polymeric cover 16 may be at least one of polyoxymethylene, acrylonitrile, styrene acrylonitrile, styrene butadiene rubber, polyetheretherketone, or polyarylethereketone.

The combination of the polymer and thickness, each set forth above, of the polymeric cover 16 may limit or prevent adsorption and/or absorption of chemicals by the core 14. Absorption may include conditions where foreign molecules penetrate into a material. Once the molecules penetrate, they may react with the material causing deterioration in the properties of the material. For example, a polycarbonate polymer may absorb molecules that subsequently react with the carbonate groups causing a chemical change within the polycarbonate. The reaction generally causes degradation in the material properties of the polycarbonate. In the worst case, the reaction can cause scission of the polycarbonate molecule. In other cases, the absorbed molecule may allow the polymer chains to more readily slide past one another or rearrange under the influence of an imposed load. With regard to adsorption, adsorption may involve attachment of chemical species to the surface of the material. Chemicals adsorbed on the surface may cause chemical changes in an outer layer of the material. The chemically-changed layer can, for instance, be more easily worn away which would expose a new surface of the material whereby the adsorption-wear cycle may begin anew. Thus, adsorption and absorption of chemicals from the oral environment may lengthen orthodontic treatment time because the material from which the bracket is made deteriorates and causes the bracket to perform poorly.

In one embodiment, the thermoplastic or thermoset polymer of the polymeric cover 16 may limit or prevent adsorption and/or absorption of chemicals by the core 14. To that end, the polymer of the polymeric cover 16 may be characterized as having a significant cross-link density. Cross-links are bonds that link one polymer chain to an adjacent chain. This may include an interchain covalent-bonded, 3-dimensional structure where chains cannot easily slip past one another even in the presence of absorbed chemicals. Not intending to be bound by theory, the cross-link density may limit the amount of absorbent from entering and/or passing completely through the cover 16. Cross-links in the polymer of the polymeric cover 16 may produce a tightly woven net of polymer chains which may sterically hinder an absorbent molecule's mobility within the polymeric cover 16. By contrast, polymers having linear, uncross-linked chains may allow absorbed molecules to penetrate into and pass more readily through the cover 16.

In one embodiment, while preventing molecules from penetrating through the polymeric cover 16 to the core 14, the polymeric cover 16 may adsorb and absorb molecules. In this case, a gradient of absorbent molecules may form in the cover 16 between the outer surface thereof and the interface between the polymeric cover 16 and the core 14. However, at the interface between the cover 16 and core 14, there is no significant presence of detrimental chemical species such that there is virtually no opportunity for the core 14 to adsorb or absorb those species. Thus, the polymeric cover 16 prevents degradation of the core 14 by preventing or reducing exposure of the core 14 to detrimental chemical species.

In one embodiment, the polymer of the polymeric cover 16 absorbs and/or adsorbs or uptakes a greater weight percentages of those chemicals than the material of the core 14. Uptake may be measured by standard test methods known in the art, such as ISO 4049, and may include gravimetric measurements by exposing the material to various chemicals and measuring the material's weight gain. The uptake of the material being the amount of weight gain observed when absorption and adsorption reach equilibrium, that is, when the material is saturated with the foreign chemical and no additional weight gain is observed with further exposure. Adsorption and/or absorption of these chemicals may be due to the nature of the polymer of the polymeric cover. For example, and without intending to be bound by theory, polymers, like polyurethane, may have more polar groups than, for example polyethylene, such that these polymers likely repel oils but may attract and absorb/adsorb more polar molecules (e.g., water). Thus, a polyurethane polymeric cover may absorb those molecules to a greater degree than a polymer having a lower percentage of polar groups. However, despite having a greater uptake, the properties of the polymer may not deteriorate and the polymeric cover 16 may prevent passage of absorbed chemicals to the interface between the cover 16 and the core 14.

In addition, the polymer of the polymeric cover 16 may be relatively insensitive to any absorbed and adsorbed chemicals. Therefore, the polymer may absorb and/or adsorb chemicals while the properties of the polymeric cover 16 remain substantially unchanged. With regard to uptake of chemicals found in the oral environment and deterioration of properties, in one embodiment, the polymer of the polymeric cover 16 may uptake up to about 5 wt. % of these chemicals though without substantial deterioration in the properties. By way of a particular example, a highly cross-linked polyurethane may uptake about 1.6 wt. % water and may uptake about 3.0 wt. % of absorbents when exposed to mouthwash (like LISTERINE® which has about 27 wt. % ethanol, antibacterial ingredients, and other potential absorbents) without substantial change in the properties thereof. By way of comparison, a 20 wt. % glass filled, uncross-linked polycarbonate may uptake about 0.2 wt. % water and about 0.3 wt. % mouthwash. The uptake of 0.2 wt. % or 0.3 wt. % of water or mouthwash, respectively, causes a large decrease in the properties of the polycarbonate thereby making the use of polycarbonate in the oral environment problematic.

While the polymeric cover 16 may be a polymer that is different from the material of the core 14, as provided above, in one embodiment, the core 14 may be made of a polymer that is a different grade of the same base polymer backbone structure. For example, the core 14 may be made of a polycarbonate with the polymeric cover 16 made of a cross-linked polycarbonate, such as that described in U.S. Pat. Nos. 4,604,434; 4,636,559; 4,701,538; 4,767,840; and 5,162,459, which are incorporated by reference herein in their entirety. By way of further example, the polymeric cover 16 may be made of a poly-(diethyleneglycol-bis-(allyl carbonate)) and/or co-polymers thereof, which may be referred to as CR-39 and which may be more compatible with some polycarbonate cores.

With reference to FIG. 3, in one embodiment, where the core 14 is made of a polymer, the body 12 may further include an insert 74. The insert 74 may further improve at least one mechanical property, such as rigidity, of the core 14. The insert 74 is covered by the polymeric cover 16 and may also be encased within the core 14 or alternatively, it may form a surface thereof, as shown. For example, the insert 74 may form one or more of surfaces 62, 64, 66 of the core slot 68. The insert 74 may be a metal or a ceramic or a combination thereof as set forth above.

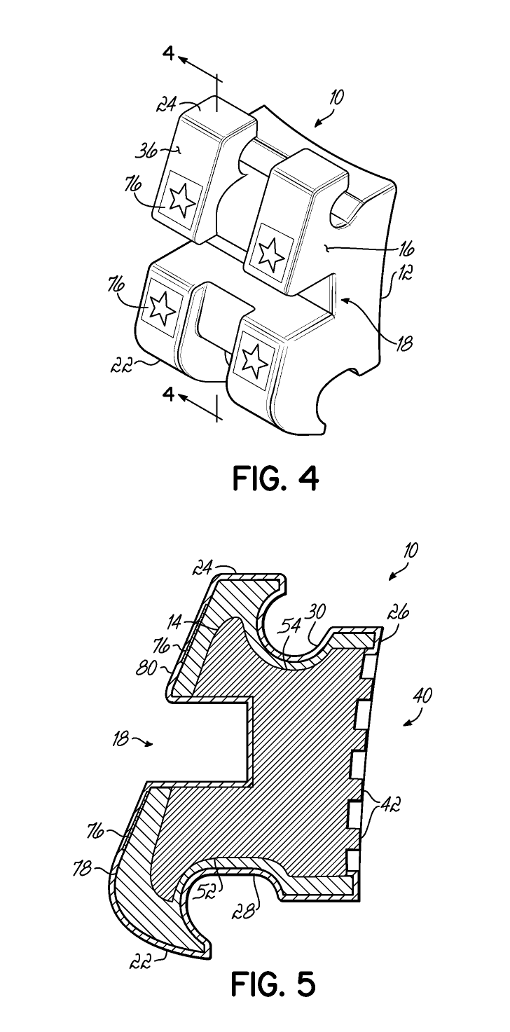

With reference to FIGS. 4 and 5, in one embodiment, the polymeric cover 16 includes an insignia, identifier, colorant, or decorative element 76. For example, the insignia, identifier, colorant, or decorative element 76 may be a trademark, may identify the quadrant for which the bracket 10 is designed to be used, and/or may be a patient generated design. By way of example, the insignia, identifier, colorant, or decorative element 76 may be incorporated into the polymeric cover 16 or may be between first and second polymeric covers 78, 80 that cover the core 14. The decorative element 76 may be positioned to be visible through the labial side 36 of the body 12 during orthodontic treatment. In another embodiment, the polymeric cover 16 contains additives, such as fluoride or anti-bacterial additives.

As introduced above, at least the polymeric cover 16 is made by an overmolding, stage molding, co-injection molding, casting, or other similar process, such as compression and rotational molding techniques, collectively referred to herein as overmolding. The overmolding technique selected may depend upon a variety of factors, for instance, compression and rotational molding techniques may be preferred for overmolding the polymeric cover 16 when the inclusion of a reinforcing agent, such as, chopped fibers, is desired. Overmolding of at least the polymeric cover 16 via one or more of these techniques allows control of the variation in thicknesses of the polymeric cover 16 at different locations. However, overmolding the body 12 may include forming the core 14 in a mold that is undersized in at least one dimension compared to a corresponding dimension of the body 12. For example, to provide for a minimum thickness between the core slot 68 and the archwire slot 18, the undersized mold has a minimum reduction in dimension in this area compared to a mold used to form the body 12. Similarly, for a maximum thickness of the polymeric cover 16 on the labial side 36 of the body 12, the undersized mold has a maximum reduction in dimension in this area between the undersized mold and the mold used to form the body 12. In this manner, the exact dimensions of the core 14 and thicknesses of the polymeric cover 16 may be predetermined and controlled such that the mechanical and physical properties of the bracket 10 may be established in an accurate, repeatable, and cost effective manner.

Once the core 14 is formed, it is removed from the undersized mold and is placed into a second mold having a cavity the size and shape of the body 12. Since the core 14 has at least one dimension that is smaller than a corresponding dimension of the body 12, there is a gap between the core 14 and the cavity of the mold. A second forming operation is used to form the polymeric cover 16 over the core 14 by injecting or casting a polymeric material into the gap. In other words, the second or overmolding operation of the polymeric cover 16 fills the void space created by the differences in dimensions between the polymeric core 14 and the body 12. The second forming operation may be similar to or different than that used to form the core 14. It will be appreciated that the second forming process may depend on the polymer selected for the polymeric cover 16.

Co-injection molding may include forming the core 14 or the polymeric cover 16 in a mold and then subsequently forming the polymeric cover 16 or core 14 in the same mold. The subsequently formed portion (i.e., cover 16 or core 14) fills a cavity formed by either the core 14 or the polymeric cover 16 and the vacant portion of the mold. For example, the cover 16 may be initially formed such that it sticks to the mold cavity to form a cavity within the cover 16. The core 14 is then formed within the cavity created by the cover 16. Additionally, co-injection molding may include substantially simultaneous or slightly staggered formation of the core 14 and the polymeric cover 16 in one mold. Thus, one or both of the core 14 and cover 16 are formed at nearly the same time or at slightly staggered times. Forming the core 14 and/or the polymeric cover 16 according to any of the above-mentioned techniques includes, for example, injection molding or casting the materials for the core 14 or the polymeric cover 16.

Any one of overmolding, stage molding, or co-injection molding may include reaction injection molding (RIM) either one or both of the polymeric cover 16 and the core 14. In reaction injection molding, liquid materials are injected into a mold. Once injected, the liquid materials polymerize. A three-dimensional highly cross-linked material is usually the result. However, where RIM is not utilized, cross-linking may include exposing the core 14 or polymeric cover 16 to an electron source in the form of a beam or providing an additive, such as a cyano-type monomer, to at least the polymer, for instance a nylon, of the polymeric cover 16 during molding where the additive initiates cross-linking of the polymer. In addition, cross-linking may be achieved by a combination of the above. For example, subsequent exposure to an electron source can activate a previously supplied additive to cross-link the polymer. Further, other additives may include those that initiate a cross-linking reaction if the polymer absorbs a specific chemical, like water. By way of example, and not limitation, other additives may be added to the material of the core 14, the cover 16, or both the core 14 and the cover 16, that modify a property of the respective core 14 or cover 16, though that additive may not participate or otherwise influence, for example, cross-linking of a polymer of the core 14 or the cover 16.

In one embodiment, the core 14 is made by injection molding a polycarbonate into a first mold. The core 14 formed is at least about 125 μm smaller in at least one dimension than the desired body 12. The core 14 is placed into a second mold and a thermosetting polyurethane, is injected or cast around the core 14 to form the polymeric cover 16. This may be achieved, for instance, in a manner similar to the method and materials described in U.S. Pat. No. 5,653,588, assigned to CDB Corporation, Leland N.C., which is incorporated by reference herein in its entirety.

In one embodiment, once the core 14 is formed, the surface of the core 14 may be roughened. Roughening provides a greater surface area which may enhance any mechanical interlocking of the polymeric cover 16 to the core 14. For example, the core 14 may be roughened by grit blasting. Moreover, in one embodiment, the surface of the core 14, which is formed according to one or more of the processes described above, may be activated prior to forming the polymeric cover 16. Activating the surface of the core 14 may facilitate improved bonding between the core 14 and the cover 16. The bonding between the core 14 and cover 16 provides resistance to delamination and seepage of materials between the core 14 and cover 16 and generally improves the appearance, durability, and overall performance of the body 12. Activating the surface of the core 14 may include priming or attaching a coupling agent to the surface of the core 14. One exemplary approach is to physically meld the coupling agent into the surface of a polymer core. This may be achieved by reducing the core size by exposing its surface to a solvent and then quenching the core 14 (a solvent and quenching process are described below). The agent may then be implanted, embedded into, or physically secured to or within the surface of the core 14. Where the core 14 is made of a polymer, the coupling agent may include, for instance, materials that have pendant isocyanate (NCO) or hydroxyl (OH) functionality. This may facilitate chemical reaction with a polyurethane cover. The solvent may be selected to be inert toward the coupling agent to preserve the functionality of the agent toward the material of the cover 16. In one example, when the core 14 is a glass-filled polycarbonate, a coupling agent, like 3-glycidyloxypropyl (dimethoxy) methylsilane (available from TCI America), in a solvent, such as chloroform, could be used to connect to or intertwine with polycarbonate polymer chains and the methoxy groups will react with the hydrolyzed surface of the glass reinforcement material. The pendant epoxy functionality may be, for example, converted into polyurethane-ready hydroxyl chemistry for reacting or chemical bonding with a polyurethane cover. In this method, both the polycarbonate and the glass surfaces may be used to couple a subsequently overmolded cover 16 to the core 14.

In another exemplary approach, a coupling agent may initially react with the surface of the core and the reacted coupling agent could then react with the polymer of the cover. For example, ester linkages of the coupling agent that focus on the carbonyl reactive site of a polycarbonate core could be used. Such a coupling agent could, for example, react with the carbonyl reactive sites. The reaction between the agent and the carbonyl reactive site may yield a new functional site along a portion of the reacted coupling agent. The new functional site would then react with the polymer of the cover. For example, the new functionality may be isocyanate or hydroxyl functionality that reacts with polyurethane.

The above-mentioned techniques used to activate the surface of the core 14 (i.e., embedding the coupling agent in the surface of the core and reacting the coupling agent with the surface of the core 14 to produce new functionality) may exclude the use of fluoropolymers, like polytetrafluoroethylene (PTFE). Fluoropolymers, because of their inert nature, are difficult to bond to. In other words, any bonding between the core 14 and a cover made of a material like PTFE may be weak at best. Weak bonding between the core 14 and a fluoro polymer may allow the cover to delaminate or detach during use. Thus, weak bonding may make the use of fluoropolymers as a cover material impracticable. Moreover, while fluoropolymers are chemically resistant (i.e., stain resistant), as noted above, fluoropolymers do not usually exhibit other advantageous characteristics, for example, they generally lack both the abrasion resistance and creep resistance that are necessary to fulfill the functions of the cover 16 set forth above.

In one alternative method of forming the core 14, a preform (not shown) is formed prior to forming the core 14. The preform may be made by injection molding or other suitable molding technique. The preform may be shaped and sized similar to the body 12. In that regard and in one embodiment, the preform is an existing bracket which saves the time and capital costs required to make molds to independently manufacture the core 14. Once the preform is formed, a portion of the surface of the preform may be removed to form the core 14. Removing a portion of the surface may include etching, dissolving, or vaporizing the surface of the preform to form the core 14. It will be appreciated that each removing technique will depend on the core material. For example, dissolving the surface of the preform may include submerging a polymeric preform into an appropriate solvent (for example, a suitable solvent for polycarbonate is chloroform) for a time and at a temperature sufficient to remove the desired depth of material. Subsequent treatment of the core 14 may include quenching the core 14 in a non-solvent to slow or halt any additional etching of the core 14 by residual solvent that clings to the surface thereof and/or embedding a coupling agent into the surface of the core, as set forth above. Alternatively, the surface of the preform may be vaporized via a laser or may be milled away with an electron beam at preselected areas to preselected depths. Once prepared, the core 14 is placed into a mold and the polymeric cover 16 may be formed over the surface of the core 14. The polymeric cover 16 at least fills the voids created by removing portions of the preform. Thus, the portion removed may be selected in order to enhance selected physical and/or mechanical features of the bracket 10 by varying the thickness of the polymeric cover 16 over the core 14, as set forth above.

The polymeric cover 16 is unlike a coating formed by, for example, spraying, dipping, painting, or depositing or other micro-coating techniques that rely on the shape or geometry of the core 14 to produce the final bracket design. As is known, these techniques often produce thin coatings that are on the order of angstroms to nanometers for deposited coatings and microns to tens of microns for painted, sprayed, or flow coatings. These coating are, therefore, insufficient to adequately protect the coated substrate from degradation in the oral environment. The polymeric cover 16 is substantially thicker than a coating made by these micro-coating techniques.

Other problems are also associated with some micro-coating techniques. For instance, some are prone to creating puddles of the coating material at abrupt changes in the geometry of the bracket. This can result in regions in the coating that are too thick. These techniques are also prone to producing areas that are too thin. Often regions that are too thick or too thin form on the same part. For example, dipping can cause undesirable buildup (i.e., regions where the coating is too thick) in the corners of the archwire slot. The buildup may cause problems fitting an archwire into the archwire slot. On the other hand, dipping may also result in regions that are too thin. In particular, dipped coatings formed on the labial, gingival, and/or occlusal surfaces of tie wings may be too thin, which is the area where it is more desirable for increased thickness. Moreover, attempts to optimize the thickness of the coatings to avoid areas that are too thin often fail to maintain reasonable minimal fillet in corners resulting in overly thick coatings in these areas. Consequently, obtaining controlled variable thicknesses is beyond the capability of each of these techniques.

In addition, the polymeric cover 16 is unlike a hard coating like silica or diamond-like coatings (DLCs). Hard coatings have a tendency to spall or flake off of a more flexible underlying surface leaving the substrate exposed. In contrast, the polymeric cover 16 is a substantially continuous cover material that is bonded to and flexes with the core 14 such that the polymeric cover 16 remains permanently attached to the core 14.

While the present invention has been illustrated by a description of various embodiments and while these embodiments have been described in some detail, it is not the intention of the inventor to restrict or in any way limit the scope of the appended claims to such detail. Thus, additional advantages and modifications will readily appear to those of ordinary skill in the art. The various features of the invention may be used alone or in any combination depending on the needs and preferences of the user.

What is claimed is:

1. An orthodontic bracket having an archwire slot adapted to receive an archwire therein, the bracket comprising:
a core, and
an overmolded polymeric cover covering the core, the polymer of the overmolded polymeric cover being cross-linked, whereby the thickness and the cross-linked density of the overmolded polymeric cover are sufficient to limit chemicals found in an oral environment from passing through the overmolded polymeric cover during orthodontic treatment.

2. The bracket of claim 1, wherein the thickness of the overmolded polymeric cover is at least about 100 μm thick in the archwire slot.

3. The bracket of claim 1, wherein the material of the core is more rigid than the polymer of the overmolded polymeric cover.

4. The bracket of claim 1, wherein the overmolded polymeric cover comprises at least one of polysulphone, acrylic, polyamide, acrylonitrile-butadiene-styrene terpolymer, or polyethylene terephthalate.

5. The bracket of claim 1, wherein the overmolded polymeric cover comprises at least one of polyoxymethylene, acrylonitrile, styrene acrylonitrile, styrene butadiene rubber, polyetheretherketone, or polyarylethereketone.

6. The bracket of claim 1, wherein the core comprises a polycarbonate and the overmolded polymeric cover comprises a polyurethane or an ionomer such that the thinnest portion of the overmolded polymeric cover substantially prevents water or other chemicals found in an oral environment from passing through the overmolded polyurethane cover during orthodontic treatment.

7. The bracket of claim 1, wherein the material of the core is a polymer that is different from the polymer of the overmolded polymeric cover, the polymer of the overmolded polymeric cover having a greater water absorption than the polymer of the core.

8. The bracket of claim 1, wherein the core comprises a polycarbonate or an ionomer.

9. The bracket of claim 8, further comprising:
an insert for improving at least one mechanical property of the core, wherein the insert is covered by the overmolded polymeric cover.

10. The bracket of claim 1, wherein the core together with the polymeric cover have a luminous transmittance of not less than 40%.

11. The bracket of claim 1, wherein the overmolded polymeric cover varies in thickness.

12. The bracket of claim 1, wherein the overmolded polymeric cover encapsulates the core.

13. A method of making an orthodontic bracket having an archwire slot for receiving an archwire therein, the method comprising:
providing a core; and
overmolding a polymeric cover over at least a portion of the core and cross-linking the polymer of the polymeric cover, whereby the thickness and the density of cross-links of the overmolded polymeric cover are sufficient to limit water or other chemicals found in an oral environment from passing through the overmolded polymeric cover during orthodontic treatment.

14. The method of claim 13, wherein providing the core includes removing at least a portion of the surface of a preform to form the core.

15. The method of claim 14, wherein removing includes at least one of etching, dissolving, or vaporizing the surface of the preform to form the core.

16. The method of claim 13, further comprising:
roughening the surface of the core before overmolding to provide high surface area or mechanical interlocking of the polymeric cover to the core.

17. The method of claim 13, wherein overmolding the polymeric cover includes overmolding the polymeric cover such that the overmolded polymeric cover has a minimum thickness of at least about 100 μm.

18. The method of claim 13, wherein overmolding includes placing the core in a mold cavity having a shape of the orthodontic bracket and injecting the polymer of the polymeric cover between the core and the mold cavity surface to form the polymeric cover.

19. The method of claim 13, wherein overmolding the polymeric cover includes overmolding a thickness of at least about 100 μm in a selected area of the orthodontic bracket that includes an occlusal tie wing of the orthodontic bracket.

20. A method of molding an orthodontic bracket comprising:
injecting a first polymer into a mold cavity to form a polymeric core, and
injecting a second polymer into the mold cavity to form an overmolded polymeric cover over at least a portion of the polymeric core, the overmolded polymeric cover having a thickness sufficient to limit water or other chemicals found in an oral environment from passing through the overmolded polymeric cover during orthodontic treatment.

21. The method of claim 20, wherein injecting the second polymer includes reaction injection molding the second polymer to form the polymeric cover.

22. The method of claim 20, further comprising:
cross-linking the polymeric cover following injecting.

23. The method of claim 20, wherein cross-linking includes exposing the polymeric cover to an electron source.

24. The method of claim 20, wherein injecting the second polymer includes providing an additive to the second polymer, the additive initiating cross-linking of the second polymer.
